(19) United States
(12) Patent Application Publication
(10) Pub. No.: US 2012/0127826 A1
(43) Pub. Date: May 24, 2012

(54) MIXING APPARATUS OF THE CDDM- OR CTM-TYPE, AND ITS USE

(76) Inventors: Christopher John Brown, Derbyshire (GB); Graeme Neil Irving, Bebington, Wirral (GB); Adam Jan Kowalski, Bebington, Wirral (GB)

(21) Appl. No.: 13/146,650

(22) PCT Filed: Feb. 3, 2010
(86) PCT No.: PCT/EP10/51294

§ 371 Date: Feb. 9, 2012

(30) Foreign Application Priority Data
Feb. 9, 2009 (GB) 0901955.5

(51) Int. Cl. B01F 7/00; B01F 3/00

(52) U.S. Cl. 366/297

(57) ABSTRACT

The invention provides a distributive and dispersive mixing apparatus of the CDDM or CTM type comprising two spaced-apart mutually rotatable confronting surfaces (1, 2) having cavities (3) therein. The surfaces have preferably relatively widely-spaced, axially-disposed confronting surfaces which alternate with preferably relatively narrowly-spaced, radially-disposed confronting surfaces, thereby preventing any leakage flow through the mixer and allowing expansion during operation with reduced danger of contact of the radially-disposed confronting surfaces.

### TECHNICAL FIELD

The present invention relates to mixing apparatus for fluids and in particular, to flexible mixing devices which can provide a range of mixing conditions.

### BACKGROUND OF THE INVENTION

It is recognised that mixing can be described as either distributive or dispersive. In a multi-phase material comprising discrete domains of each phase, distributive mixing seeks to change the relative spatial positions of the domains of each phase, whereas dispersive mixing seeks to overcome cohesive forces to alter the size and size distribution of the domains of each phase. Most mixers employ a combination of distributive or dispersive mixing although, depending on the intended application the balance will alter. For example a machine for mixing peanuts and raisins will ideally be wholly distributive so as not to damage the things being mixed, whereas a blender/homogeniser will be dispersive.

Many different types of rotor/stator mixer are known. Stirring reactors such as those disclosed in US 2003/0139543 comprise a vessel with internally mounted mixing elements and are generally distributive in function. Other types of rotor-stator mixer (such as that disclosed in WO 2007/105323 are designed with the intention of forming fine emulsions and are dispersive in character. DE 1557171 discloses a mixer with a plurality of alternately rotating and static, concentric cage-like elements through which the flow is radial.

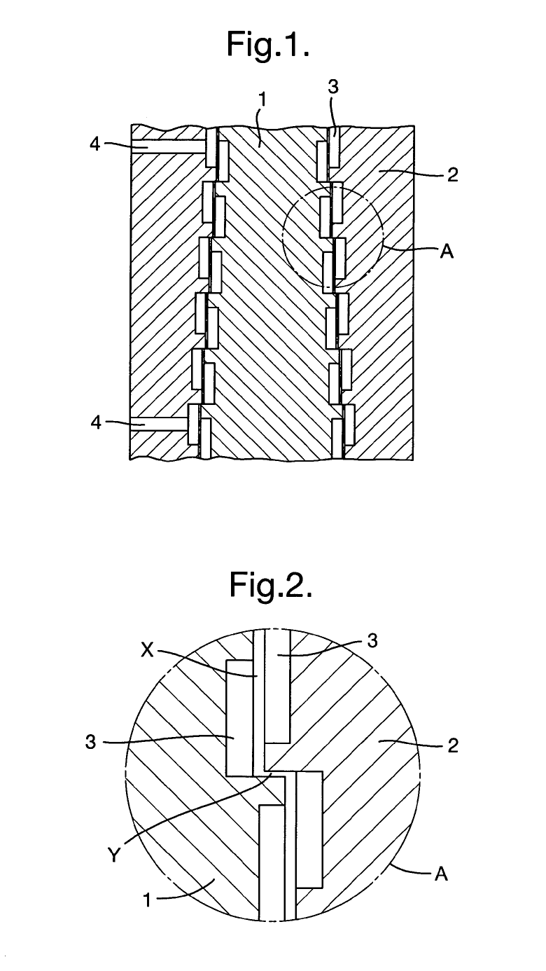

EP 0799303 and GB 2118058 describes a known mixer type hereinafter referred to as a “Cavity Transfer Mixer” (CTM). The CTM comprises elements which define confronting surfaces, each having a series of cavities formed therein, in which the surfaces move relatively to each other and in which a liquid material is passed between the surfaces and flows along a pathway successively passing through the cavities in each surface. In FIG. 1 of GB 2118058, the confronting surfaces are the inner surface of a sleeve and the outer surface of a co-axially disposed inner drum. The cavities are arranged so that they overlap forming sinuous flow paths which change as the drum and the sleeve rotate relative to each other. The type of mixer shown in GB 2118058 has stator and rotor elements with opposed cavities which, as the mixer operates, move past each other across the direction of bulk flow through the mixer. In such mixers, primarily distributive mixing is obtained. Shear is applied by the relative movement of the surfaces in a generally perpendicular direction to the flow of material. In such a device there is relatively little variation in the cross-sectional area for flow as the material passes axially down the device. Generally, the cross-sectional area for flow (due to the cavities) varies by a factor of less than 3 through the apparatus. Absent the cavities, the “metal to metal” separation between the inner surface of the sleeve and the surface of the drum is essentially constant.

The commercial application of CTMs has been largely restricted to the thermoplastics' conversion industry, where CTM technology originated (see EP 048590). In part this is because established rotor/stator devices, such as “Silverson” mixers, offer some of the benefits and at a significantly lower cost.

In some mixers, such as that described in EP 0434124 a cage-like rotor and stator elements are configured such that the bulk flow must pass through relatively narrow spaces within the mixer. Similar alternation of relatively wide and relatively narrow flow spaces, for the purpose of forming an emulsion, are known from GB 129757. However GB 1297757 and EP 0434124 are not CTM's as the relatively wide spaces form annuli and there it little or no alteration of the flow path geometry as the rotor and stator move.

EP 0799303 also describes a novel mixer, hereinafter referred to as a “Controlled Deformation Dynamic Mixer” (CDDM). In common with the CTM, type of mixer has stator and rotor elements with opposed cavities which, as the mixer operates, move past each other across the direction of bulk flow through the mixer. It is distinguished from the CTM in that material is also subjected to extensional deformation. The extensional flow and efficient dispersive mixing is secured by having confronting surfaces with cavities arranged such that the cross sectional area for bulk flow of the liquid through the mixer successively increases and decreases by a factor of at least 5 through the apparatus. In comparison with the embodiment of the CTM described above, the cavities of the CDDM are generally aligned or slightly offset in an axial direction such that material flowing axially along the confronting surfaces is forced through narrow gaps as well as flowing along and between the cavities. The CDDM combines the distributive mixing performance of the CTM with dispersive mixing performance. Thus, the CDDM is better suited to problems such as reducing the droplet size of an emulsion, where dispersive mixing is essential. As with the CTM disclosed in GB 2118058 it is worth noting that the normal spacing of the confronting surfaces (absent the cavities) is constant along the length of the mixer.

GB 2308076 shows several embodiments of a mixer comprising a co-called “sliding vane” pump. These include both drum/sleeve types where the bulk flow is along the axis of the mixer and mixers in which the flow is radial. Many other types of mixer can be configured either as the drum/sleeve type or the “flat” type. For example DD207104 and GB 2108407 show a mixer comprising two movable confronting surfaces with projecting pins which cause mixing in material flowing in a radial direction between the plates.

Both the CTM and the CDDM can be embodied in a “flat” form where the drum and the sleeve are replaced with a pair of disks mounted for relative rotation and the cavities are provided in the confronting surfaces of the disks. In this modified “flat” form the bulk flow is generally radial.

For CTM and CDDM devices of the types described in EP 0799303, there are internal pathways which potentially enable material to flow through the devices without transfer between rotor and stator cavities on the confronting surfaces in the intended manner. Such flows are termed “leakage flows”, and such leakage flows are believed to reduce the uniformity and efficiency of mixing and reduce hygienic security through the stagnation of material within the cavities.

An important further consideration with certain CTM and CDDM designs concerns the relative axial positions of rotor and stator components during operation which are critical to performance. Such relative positions may change by axial displacement of the rotating parts with respect to the static parts and this may compromise critical clearances. Under “normal” operating conditions, such displacement is resisted through thrust bearings, an approach which becomes more difficult at high pressures and mixer speeds.

There are practical limits to the spacing between the confronting surfaces in the CDDM and CTM. For example, in the case of a rotor/drum and stator/sleeve device, as the device is heated, expansion may mean that the rotor/drum expands in a radial direction. The stator/sleeve may expand less as it is better able to lose heat. This can result in a narrowing of the gap between the confronting surfaces and even contact. At high operating speeds, contact between the surfaces can be catastrophic.

Further difficulties arise from the high shear rates which are encountered in mixers with very closely confronting surfaces. High shear rates lead to high shear stress (which is a function of shear rate and viscosity). These shear stresses lead to a high torque (which is related to the shear stress for a given geometry). For a fixed angular velocity of the mixing elements the power consumption is directly related to the torque. Hence mixers which employ high shear rates typically require large power inputs. This is not only expensive, but can produce unwanted heating of the material being processed.

### BRIEF DESCRIPTION OF THE INVENTION

We have determined that the rotational CTM/CDDM type mixer can be significantly improved by alternating regions of axially-separated confronting surfaces with regions of radially-separated confronting surfaces.

Accordingly the present invention provides a distributive and dispersive mixing apparatus of the controlled deformation dynamic mixer (CDDM) type or cavity transfer mixer (CTM) type comprising elements (1, 2) defining two spaced-apart confronting surfaces having cavities (3) therein which said surfaces on relative rotational motion of the elements (1, 2) function as a cavity transfer mixer (CTM) CHARACTERISED IN THAT in said surfaces regions of axially-spaced confronting surfaces (Y) alternate with regions of radially-spaced confronting surfaces (X) and in that at least some of the radially-spaced confronting surfaces define cavities which on relative rotational motion of the elements (1, 2) function as a cavity transfer mixer (CTM).

By ensuring that the surfaces are “stepped” in the manner described above, leakage flows in the form of linear movement of fluid within the mixer is no longer possible. The terms “radial” and “axial” refer to surfaces (ignoring cavities in the surfaces) which are separated in a radial or respectively axial direction relative to the relative axis of rotational motion of the elements of the mixer. Thus, two regions of the confronting surfaces which are spaced apart along the axial direction would be axially-spaced confronting surfaces and the bulk flow between the surfaces would be radial. The actual direction of the spacing of at least one and preferably both of the axially- or radially-spaced confronting surfaces can vary by up to 20 degrees from the true axial or radial direction, but preferably at least one of these spacing directions differs from the true axial or radial direction by less than 10 degrees.

Typically the confronting surfaces are provided by a cylindrical drum having regions of progressively increasing radius and a co-axial sleeve having an inner surface having a profile which conforms closely to that of the drum. In such an apparatus, the spacings between the confronting surfaces are preferably either predominantly fully radial or fully axial.

The operating parameters of the mixing apparatus according to the present invention will vary according to the application envisaged. For example where the process stream is of low viscosity emulsion the apparatus will typically have a rotor speed of more than 1000 rpm and a residence time which could be as low as of tens of microseconds. The closest confronting surfaces will typically be 50 microns or less apart, preferably with a separation in the range 10-50 microns. For more viscous materials the rotation speed will be lower and the residence time longer.

When the narrower spacing is confined to the regions where the confronting surfaces are axially spaced the risk that thermal expansion of the drum will cause the confronting surfaces to come into contact is reduced. The spacing of the confronting surfaces in the radial flow zones is maintained by axial displacement of the drum relative to the sleeve.

Thus, a mixing device according to the present invention comprises a stator member and a rotor member mounted for rotation relative to and in close proximity to the stator, the confronting surfaces of the stator and the rotor having one or more regions carrying respective rows of cavities being arranged to form a cavity transfer mixer (CTM), wherein:
a) at least one further region of the confronting surfaces defines an annular space of uniform width which is narrower than the spacing of the confronting surfaces in said region carrying respective rows of cavities, and,
b) the said annular space of uniform width is defined by surfaces which are not aligned along the axis of relative rotation of the stator and rotor.

Thus, a mixer is provided which has:
a) CTM-like regions of distributive mixing where the flow in the mixer is generally along its axis and where the confronting surfaces are spaced relatively widely, and relative movement is across the direction of bulk-flow;
b) regions of high extensional flow, to promote dispersive mixing, where the flow is more radial and the confronting surfaces are spaced more closely.

The regions where the confronting surfaces are most closely spaced are those where the shear rate within the mixer tends to be the highest. As noted above high shear contributes to power consumption and heating. This is especially true where the confronting surfaces of the mixer are spaced by a gap of less than around 50 microns. Advantageously, confining the regions of high shear to relatively short regions where the flow is radial with respect to the mixer means that the power consumption and the heating effect can be reduced, especially where in the CTM-like regions the confronting surfaces are spaced apart relatively widely. A further benefit of this variation in the normal separation of the confronting surfaces in the direction of bulk flow, is that by having relatively small regions of high shear, especially with a low residence time is that the pressure drop along the mixer can be reduced without a compromise in mixing performance. We have determined that by machining back the confronting surfaces in the CTM-like regions such that the clearance between the confronting surfaces is >2 times that of the closer regions, preferably 3-10 times that of the closer regions a very significant power requirement reduction and reduction in operating pressure are obtained.

It is especially preferred that the invention is embodied in a mixer in which the more narrowly spaced confronting surfaces, i.e. those separated in the axial direction, are not by-passed by flow through cavities, such that the bulk flow through the mixer must pass in a radial direction through a narrow annular space defined by the axially separated regions of the confronting surfaces.

In an embodiment of the present invention at least one cage-like member is disposed between the confronting surfaces. The surfaces of the cage like member conform in profile to the confronting surfaces against which they are disposed and the cage like member is stepped such that a mixer of the same type as that described above is formed between the at least one surface of the cage like member and at least one of the confronting surfaces. Flow of material through the apertures in the cage like member promotes further distributive mixing in the CTM-like regions of the mixer. A cage-like member promotes regions where the flow is highly extensional allowing the mixer to operate at lower pressures than would otherwise be the case. Preferably the or at least one cage-like member has a relative rotational movement but is not freely rotating relative to at least one of the confronting surfaces and/or at least one other cage-like member, and the bulk fluid flow within the mixing apparatus is in the plane of the surface of the or at least one cage-like member.

A further aspect of the present invention subsists in the use of the mixing apparatus of the present invention for the treatment of a liquid, emulsion, gel or other flowable composition.

### DETAILED DESCRIPTION OF THE INVENTION

For the purposes of understanding the operation of the CTM or CDDM in general, the disclosure of EP 0799303 is incorporated herein by reference. As noted above, the apparatus of the present invention is similar to the CDDM in that it comprises two confronting surfaces and in that the flow path for materials along these confronting surfaces through the mixer varies in width.

As with the CDDM and CTM there are several possible configurations for the mixing apparatus of the present invention. In one particularly preferred configuration the confronting surfaces are generally cylindrical. Any cage-like member used with such a cylindrical configuration will be generally tubular. In such a configuration the apparatus will generally comprise a cylindrical drum and co-axial sleeve. The confronting surfaces will be defined by the outer surface of the drum and the inner surface of the sleeve. However, there are alternative configurations in which the confronting surfaces are circular/disc-like. Between these two extremes of configuration are those intermediate forms in which the confronting surfaces are generally conical or frusto-conical.

The advantages provided by apparatus of the present invention are further described below with reference to a preferred embodiment of the CDDM type comprising a stepped cylindrical drum and co-axial sleeve but, as will be clear from the accompanying figures, such advantages are not limited to said preferred embodiment and many of the advantage are also obtained with the disk-like configuration and the intermediate forms.

In a preferred embodiment the radii of the confronting surfaces decrease in a stepwise manner to provide at least one region of more radial flow and the spacing of the axially-spaced confronting surfaces in said region is less than the spacing of the radially-spaced confronting surfaces in at least one region of more axial flow.

As can be seen from the figures the process-stream in the mixer encounters, sequentially, a plurality of regions in which the confronting surfaces are spaced radially and which are CTM-like followed, in the particularly preferred embodiment by regions in which the confronting surfaces are spaced axially and which bear some functional similarity to a spinning-disk homogenizer.

Preferably, there are 3-20 of the (radially spaced) regions of distributive mixing and a comparable number of the (axially spaced) regions of dispersive mixing. More preferably, there are 6-12 such pairs of regions. Although these pairs of regions can comprise parts of the apparatus which are manufactured separately and then secured together it is preferable that both the confronting surfaces and cavities therein are of monolithic construction, i.e. machined out of single pieces of metal.

Advantageously, the juxtaposition of the confronting surfaces in apparatus of the present invention causes material to flow in the intended manner through said apparatus with transfer between rotor and stator cavities in the confronting surfaces, thus limiting “leakage flows” which would reduce the uniformity and efficiency of mixing and hygienic security through the stagnation of material within the cavities. In the case of a preferred embodiment, for example, the radially extending surfaces extend across the radial gap between the confronting surfaces forcing material to move radially and thus counteract axial leakage flows.

Advantageously, the juxtaposition of the confronting surfaces in apparatus of the present invention may oppose the relative movement of the confronting surfaces which could arise from the drag flow of material against the surfaces within the said apparatus, thus maintaining the intended clearances between said surfaces and maintaining the intended performance of said apparatus.

In the case of a preferred embodiment of the CDDM-type, for example, by configuring the drum and sleeve such that the radially extending surfaces of the drum are axially upstream of the radially extending surfaces of the sleeve, axial thrust within the mixer is counteracted by the fluid pressure within the region of radial bulk flow between the closely spaced radially extending confronting surfaces, thus reducing the tendency for relative movement of the drum and sleeve which would arise in response to fluid drag forces on their surfaces.

Advantageously, the juxtaposition of confronting surfaces in apparatus of the present invention may accommodate the relative movements of the confronting surfaces which arise due to the operating parameters of temperature and pressure, and so reduces the practical limits to the spacing between said surfaces which are critical to the performance of the apparatus.

In the case of a preferred embodiment, for example, an increase in operating temperature will result in the cylindrical drum expanding in a radial direction. The co-axial sleeve may expand less as it is better able to lose heat. This can result in a narrowing of the gap between the confronting surfaces and even contact. By specifying said confronting surfaces such that they overlap radially and can be displaced radially, then the separation of said surfaces can be specified to a lower value than would otherwise be possible in the absence of such overlap.

Additional features of the known CTM and CDDM may be incorporated in the mixer described herein. For example, one or both of the confronting surfaces may be provided with means to heat or cool it. The cavities in the confronting surfaces may have a different geometry in different parts of the mixer.

In order that the present invention can be better understood it will be described by way of example and with reference to the accompanying schematic figures, in which:

FIG. 1: shows a section through a portion of a stepped rotating cylindrical drum and static co-axial sleeve controlled deformation dynamic mixer (CDDM) according to the invention;

FIG. 2: shows a detailed view of region “A” in FIG. 1;

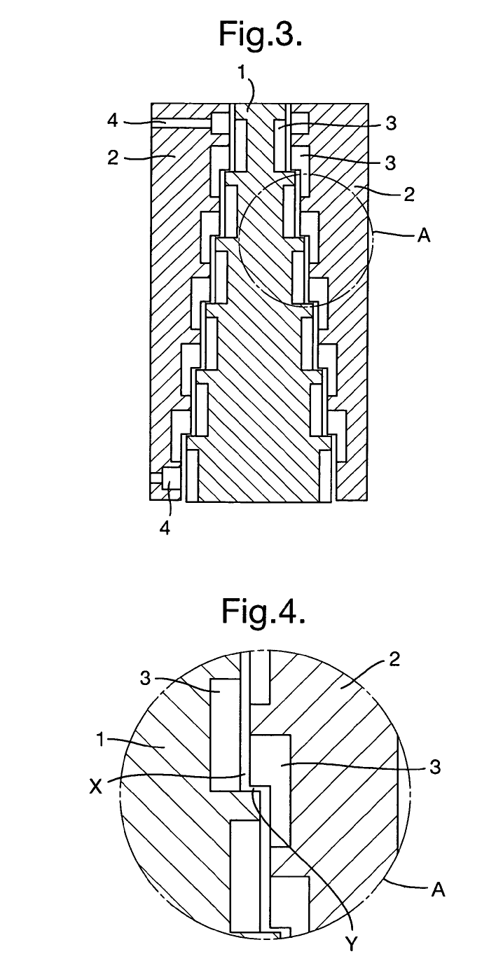

FIG. 3: shows a section through a portion of a stepped rotating cylindrical drum and static co-axial sleeve cavity transfer mixer (CTM);

FIG. 4: shows a detailed view of region “A” in FIG. 3;

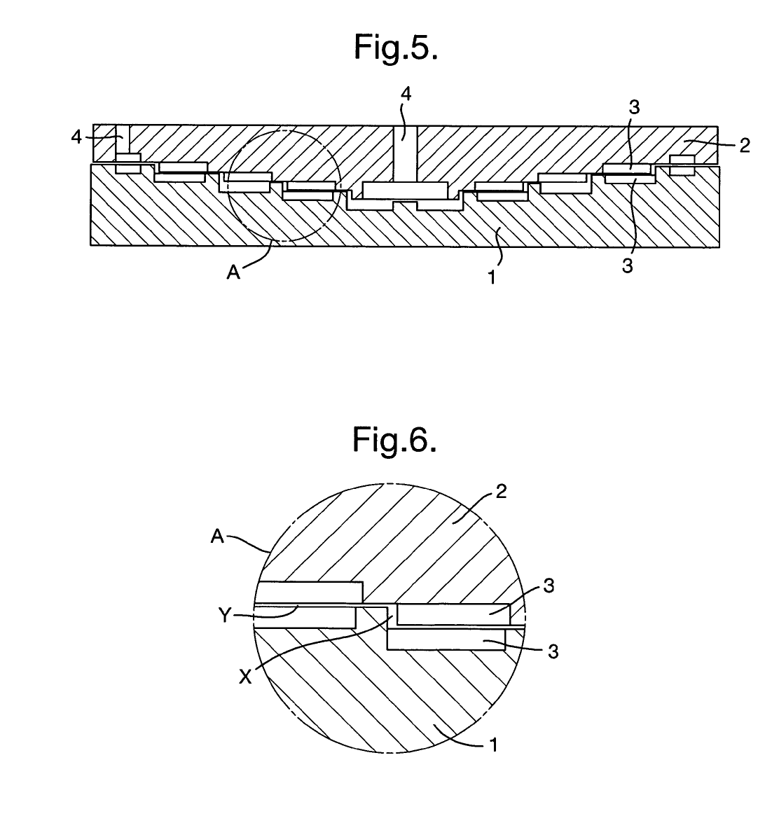

FIG. 5: shows a section through a portion of a stepped rotating and static conical surfaces controlled deformation dynamic (CDDM) mixer according to the invention;

FIG. 6: shows a detailed view of region “A” in FIG. 5;

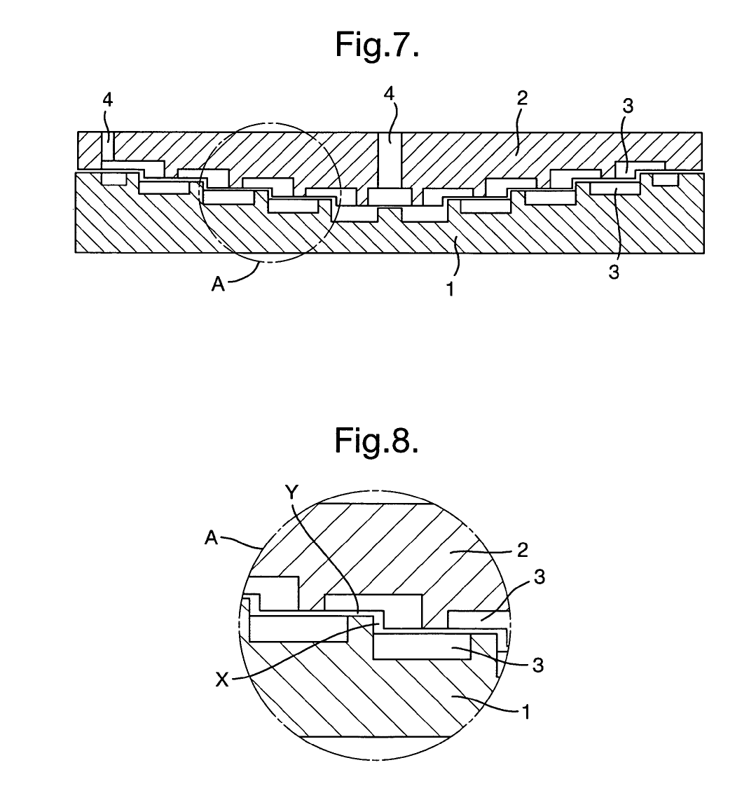

FIG. 7: shows a section through a portion of a stepped rotating and static conical surfaces cavity transfer mixer (CTM) according to the invention;

FIG. 8: shows a detailed view of region “A” in FIG. 7;

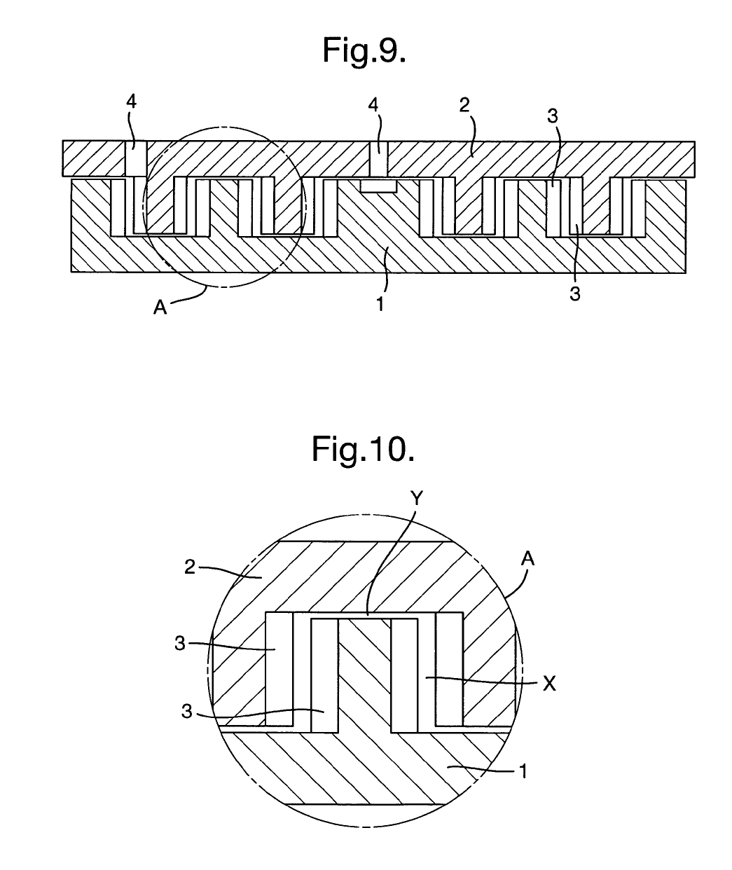

FIG. 9: shows a section through a portion of a stepped rotating and static discs controlled deformation dynamic mixer (CDDM) according to the invention;

FIG. 10: shows a detailed view of region “A” in FIG. 9;

### EXAMPLES

### 1. Stepped Rotating Cylindrical Drum and Static Co-Axial Sleeve CDDM

FIG. 1 shows, in schematic form, a portion of a mixer comprising an inner drum (1) and an outer sleeve (2). Cavities (3) are provided in the drum and the sleeve so that as the drum rotates about its axis (shown dashed), the drum and the sleeve co-operate to form a controlled deformation dynamic mixer (CDDM). Ports (4) are provided for input and output of the process flow. Means for rotating the drum relative to the sleeve and end seals are not shown. The diameter of the drum increases towards the lower part of the figure and flow of materials within the mixer is from the bottom towards the top.

It can be seen that both the inner surface of the sleeve and the surface of the drum define cavities (3) which interact to produce distributive (CTM-like) mixing as the drum rotates within the sleeve. It should be noted the cavities (3) are not annular spaces around the entire sleeve but are a series of cavities around the diameter of the sleeve. In this embodiment of the invention, there is a single row of cavities between each step in the drum and the sleeve, however it is envisaged that both in this and in other embodiments of the invention there may be a plurality of such rows between each step.

FIG. 2 provides a more detailed view of the region “A” in FIG. 1. It can be seen that in region “X” the radial spacing of the drum (1) and the sleeve (2) is relatively large as compared with the axial spacing in region “Y”. In region “X”, the cavities (3) in the radially-spaced confronting surfaces promote CTM-like distributive mixing while in region “Y” the narrower axial spacing in the radial flow path induces extensional flow and dispersive mixing. Given that the radial spacing in region “X” is relatively large, thermal expansion of the drum can be accommodated. The axial spacing in region “Y” can be modified by axial displacement of the sleeve relative to the drum, and the axial pressure in that region opposes drag flow on the drum. Radial overlap of drum and sleeve in region “Y” ensures that the potential for leakage flow is counteracted, and the relative radial thermal and pressure movements of the drum and sleeve can be accommodated.

### 2. Stepped Rotating Cylindrical Drum and Static Co-Axial Sleeve CTM

FIG. 3 shows a portion of a mixer comprising an inner drum (1) and an outer sleeve (2). Cavities (3) are provided in the drum and the sleeve so that as the drum rotates about its axis (shown dashed), the drum and the sleeve co-operate to form a cavity transfer mixer. Ports (4) are provided for input and output of the process flow. Means for rotating the drum relative to the sleeve and end seals are not shown. The diameter of the drum increases towards the lower part of the figure and flow of materials within the mixer is from the top towards the bottom.

FIG. 4 provides a more detailed view of the region “A” in FIG. 3. It can be seen that in region “X” the spacing of the drum (1) and the sleeve (2) is relatively large as compared with region “Y”. In region “X”, the cavities (3) promote CTM-like distributive mixing while in region “Y” the narrower spacing in the radial flow path induces an element of extensional flow and dispersive mixing. Given that the spacing in region “X” is relatively large, thermal expansion of the drum can be accommodated. The spacing in region “Y” can be modified by axial displacement of the sleeve relative to the drum.

While, the radial overlap of drum and sleeve in region “Y” ensures that the potential for leakage flow is to some extent counteracted, and the relative radial thermal and pressure movements of the drum and sleeve can be accommodated, there are no regions in the mixer of this example where there is extensional flow as in the CDDM.

### 3. Stepped Rotating and Static Conical Surfaces CDDM

FIG. 5 shows a portion of a mixer comprising a rotating disc (1) and a static disc (2). Cavities (3) are provided in the rotating disc and the static disc so that as the rotating disc rotates about its axis (shown dashed), the rotating disc and the static disc co-operate to form a controlled deformation dynamic mixer (CDDM). Ports (4) are provided for input and output of the process flow. Means for rotating the rotating disc relative to the static disc and end/edge seals are not shown. The flow of materials within the mixer is from the centre towards the periphery.

FIG. 6 provides a more detailed view of the region “A” in FIG. 5. It can be seen that in region “X” the radial spacing of the rotating disc (1) and the static disc (2) is relatively large as compared with the axial spacing in region “Y”. In region “X”, the cavities (3) promote CTM-like distributive mixing while the narrower axial spacing in the radial flow path at “Y” induces extensional flow and dispersive mixing.

Axial overlap of the rotating disc and the static disc in region “X” ensures that the potential for leakage flow is counteracted. In this embodiment the relative axial thermal and pressure movements of the rotating disc and the static disc can be accommodated as the spacing at “X” is wide enough to accommodate them and the narrower spacing at “Y” can be varied by displacement of the discs towards or apart from each other.

### 4. Stepped Rotating and Static Conical Surfaces CTM

FIG. 7 shows a portion of a mixer comprising a rotating disc (1) and a static disc (2). Cavities (3) are provided in the rotating disc and the static disc so that as the rotating disc rotates about its axis (shown dashed), the rotating disc and the static disc co-operate to form a cavity transfer mixer. Ports (4) are provided for input and output of the process flow. Means for rotating the rotating disc relative to the static disc and end/edge seals are not shown. The flow of materials within the mixer is from the centre towards the periphery.

FIG. 8 provides a more detailed view of the region “A” in FIG. 7. It can be seen that in region “X” the spacing of the rotating disc (1) and the static disc (2) is relatively large as compared with region “Y”. In region “Y”, the cavities (3) promote CTM-like distributive mixing.

While, the radial overlap of drum and sleeve in region “Y” ensures that the potential for leakage flow is to some extent counteracted, and the relative radial thermal and pressure movements of the drum and sleeve can be accommodated, there are no regions in the mixer of this example where there is extensional flow as in the CDDM.

### 5. Stepped Rotating and Static Discs CDDM

FIG. 9 shows a portion of a mixer comprising a rotating disc (1) and a static disc (2). Opposed series of cavities (3) are provided in the rotating disc and the static disc so that as the rotating disc rotates about its axis (shown dashed), the rotating disc and the static disc co-operate to form a CTM-like mixer. Ports (4) are provided for input and output of the process flow. Means for rotating the rotating disc relative to the static disc and end seals are not shown. The flow of materials within the mixer is from the centre towards the periphery.

FIG. 10 provides a more detailed view of the region “A” in FIG. 9. It can be seen that in region “X” the spacing of the rotating disc (1) and the static disc (2) is relatively large as compared with region “Y”. In region “X”, the cavities (3) promote CTM-like distributive mixing while in region “Y” the narrower spacing in the axial flow path induces extensional flow and dispersive mixing.

Axial overlap of the rotating disc and the static disc in region X ensures that the potential for leakage flow is counteracted. In this embodiment the relative axial thermal and pressure movements of the rotating disc and the static disc can be accommodated as the spacing at “X” is wide enough to accommodate them and the narrower spacing at “Y” can be varied by displacement of the discs towards or apart from each other.

1. A distributive and dispersive mixing apparatus of the controlled deformation dynamic mixer (CDDM) type or cavity transfer mixer (CTM) type comprising elements (1, 2) defining two spaced-apart confronting surfaces having cavities (3) therein which said surfaces on relative rotational motion of the elements (1, 2) function as a cavity transfer mixer (CTM) CHARACTERISED IN THAT in said surfaces regions of axially-spaced confronting surfaces (Y) alternate with regions of radially-spaced confronting surfaces (X) and in that at least some of the radially-spaced confronting surfaces define cavities which on relative rotational motion of the elements (1, 2) function as a cavity transfer mixer (CTM).

2. A mixing apparatus according to claim 1 wherein the confronting surfaces comprise generally cylindrical surfaces.

3. A mixing apparatus according to claim 1 wherein the confronting surfaces comprise generally conical surfaces.

4. A mixing apparatus according to claim 1 wherein the confronting surfaces comprise generally disk-like surfaces.

5. A mixing apparatus according to any of claims 1-4 wherein cavities are not provided in all the radial and axial regions.

6. A mixing apparatus according to any of claims 1-5 wherein the axial separation of the radially disposed confronting surfaces may be varied by the relative axial movement of the confronting surfaces.

7. A mixing apparatus according to any of claims 1-6 wherein the axial separation of the radially disposed confronting surfaces is larger than the radial separation of the axially disposed confronting surfaces.

8. A mixing apparatus according to claim 1 or 2 comprising a stepped cylindrical drum having coaxial regions of progressively decreasing radius and a co-axial sleeve having an inner surface profile which conforms closely to that of the drum.

9. A mixing apparatus according to any of claims 1-8 further comprising at least one cage-like member disposed between the confronting surfaces, the surfaces of the cage like member conforming in profile to the confronting surfaces against which they are respectively disposed.

10. A mixing apparatus according to any of claims 1-9 further comprising variation in the normal separation of the confronting surfaces in the direction of bulk flow.

11. Use of the mixing apparatus of any one of claims 1-10 for the treatment of a liquid, emulsion, gel or other flowable composition.
